(19) United States
(12) Patent Application Publication
(10) Pub. No.: US 2009/0109030 A1
(43) Pub. Date: Apr. 30, 2009

(54) USING A PHYSICAL OBJECT AND ITS POSITION ON A SURFACE TO CONTROL AN ENABLEMENT STATE OF A SURFACE BASED COMPUTING DEVICE

(75) Inventors: LYDIA M. DO, RALEIGH, NC (US); PAMELA A. NESBITT, TAMPA, FL (US); LISA A. SEACAT, SAN FRANCISCO, CA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/877,889

(22) Filed: Oct. 24, 2007

(51) Int. Cl. G08B 13/14; G08B 17/12

(52) U.S. Cl. 340/572.1; 340/600; 340/686.1

(57) ABSTRACT

The present invention can include a solution for toggling an enablement state of a surface based computing device using a physical object. In the solution, a physical object external to a surface based computing device can be identified, which is able to be placed on a surface of the surface based computing device. The surface based computing device can detect a change in a positioning of the physical object relative to the surface. Responsive to the change of positioning, an enablement state of the surface based computing device can be changed.

### BACKGROUND

1. Field of the Invention

The present invention relates to the field of surface based computing and, more particularly, to using a physical object and its position on a surface to control an enablement state of a surface based computing device.

2. Description of the Related Art

FIG. 1 (Prior Art) shows a schematic diagram of a conventional surface based computing device 100. Although the arrangements of device 100 are typical, variations of these components can be combined to form a device, which is still considered surface based computing device. In other words, the definition of a surface based computing device 110 is not to be limited to those typical components shown in FIG. 1. A common example of a surface-based computing device, which the current invention is not limited to, is a MICROSOFT SURFACE computing device. As shown device 100 can include a screen 105, a computing unit 110, a display projector 115, and a set of infrared projectors 120.

Computing unit 110 can contain one or more central processing units able to perform computing actions for the surface based device 100. The computing unit 110 can include many of the same components found in everyday desktop computers, such a CPU, a motherboard, RAM, a graphics card, a WIFI transceiver, a BLUETOOTH transceiver, and the like.

The screen 105 can be a horizontal surface that can incorporate multi-touch sensors. The touch-sensitive display can recognize objects by their shapes or by scanning tags (e.g., RFID tags) embedded in objects resting on the surface of screen 105. The multi-touch screen 105 can be capable of processing multiple inputs from multiple users.

Infrared projectors 120 can project infrared light onto screen 105 to be used for multiple touch sensing by computing unit 110. A “machine vision” of the surface based computing device 100 can operate in a near-infrared spectrum, such as by using an 850 nanometer-Wavelength LED light source aimed at the display 105. When objects touch the tabletop, the light reflects back and is picked up by multiple infrared cameras with an acceptable net resolution.

The display projector 115 can use rear-projection technologies, such as Digital light Processing (DLP) technologies, to project visible images to the display 105. A resolution of the visible screen can be different from the machine vision or invisible screen. For example, the visible screen can have a resolution of 1024×768, while the invisible resolution from the projectors 120 can be 1280×960, which can allow for better recognition at the edges of the display.

Situations exist in which it would be preferable to deactivate the multi-touch sensitivity of the surface-based computer's display area. For example, a user may want to pause their current computing session to resume it at a later time. The user may want to use the display area as normal table space in the meantime. In one situation, a surface-based computing device can be in a conference room. There can be a speaker present ready to give a presentation, in which case all attention would normally be given to the speaker. In this case, a user can want to pause their session on the surface-based computing device for resuming later. In another situation, a child may be using a surface-based computing device for a game or learning tool and a parent may want to control their child's usage activity by pausing their current session. Currently, there are no intuitive solutions for toggling the enablement state of a surface-based computing device.

### SUMMARY OF THE INVENTION

The present invention can be implemented in accordance with numerous aspects consistent with the materials presented herein. One aspect of the present invention can include a method for controlling an enablement state of a surface based computing device using a surface place-able physical object. In the method, a physical object external to a surface based computing device can be identified, which is able to be placed on a surface of the surface based computing device. The surface based computing device can detect a change in a positioning of the physical object relative to the surface. A positioning of the physical object can refer to which side of a multi-sided object is downward facing as well as whether a physical object is present or absent in an region of the surface based computing device. Responsive to the change of positioning, an enablement state of the surface based computing device can be changed.

Another aspect of the present invention can include a surface based computing device that includes an enablement engine and an enablement token detector. The enablement engine can be a software engine controlling an enablement state of the surface based computing device. The enablement state can include at least an active state and at least one an inactive state. State information can be preserved when the enablement engine changes from the active state to the inactive state so that when the state is changed back from the inactive state to the active state using the enablement engine, state information is restored. The enablement token detector can detect a positioning of a physical object relative to a surface of the surface based computing device, wherein different detected positionings of the physical object correspond to different enablement states. When the enablement token detector identifies a change in the positioning of the physical object, a command can be automatically conveyed to the enablement engine to synchronize the enablement state of the surface based computing device with the enablement state indicated by the physical token.

Still another aspect of the present invention can include a physical token for changing an enablement state of a surface based computing device. The physical token can include at least one unique characteristic that is configured to be detected by a surface based computing device when the physical token is placed on a surface of the surface based computing device. A positioning of the physical token relative to the surface corresponds to different enablement states for the surface based computing device. The different enablement states can include one or more active states and one or more inactive states. State information can be selectively preserved when the surface based computing device changes from the active state to the inactive state so that when surface based computing device changes back from the inactive state to the active state, state information can be restored.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (Prior Art) is a schematic diagram of a system of a surface-based computing device.

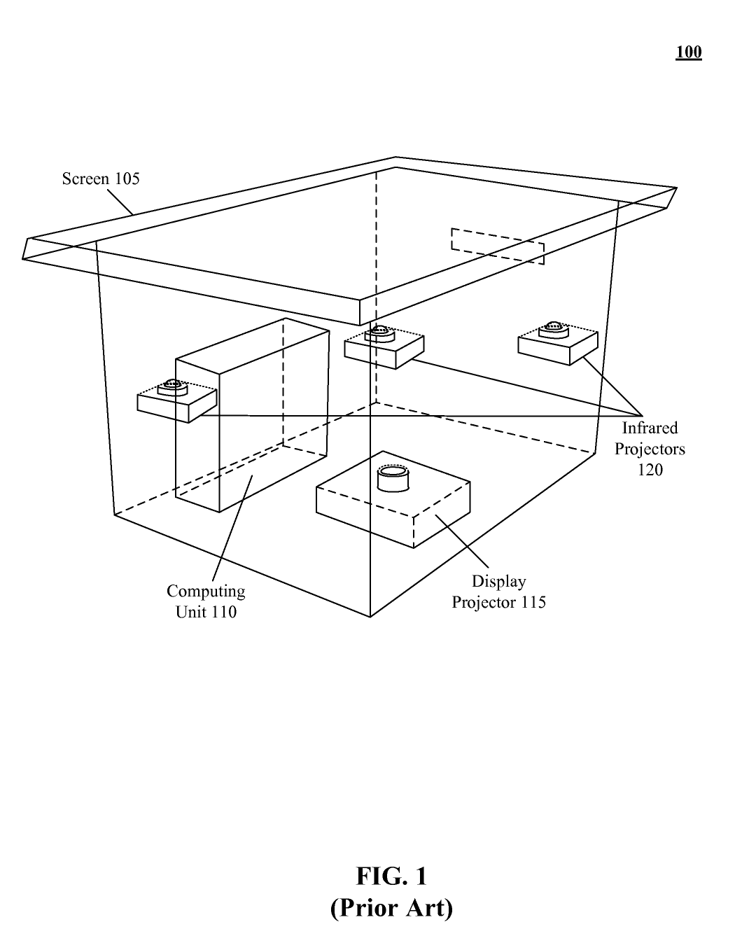

FIG. 2 is a schematic diagram of a system illustrating solutions for using a enablement token to control the enablement state of a surface-based computing device in accordance with an embodiment of the inventive arrangements described herein.

FIG. 3 is a schematic diagram of a system for using a token to control the enablement state of a surface-based computing device in accordance with an embodiment of the inventive arrangements described herein.

FIG. 4 is a flow chart of a method for using a token to control the enablement state of a surface-based computing device in accordance with an embodiment of the inventive arrangements described herein.

### DETAILED DESCRIPTION OF THE INVENTION

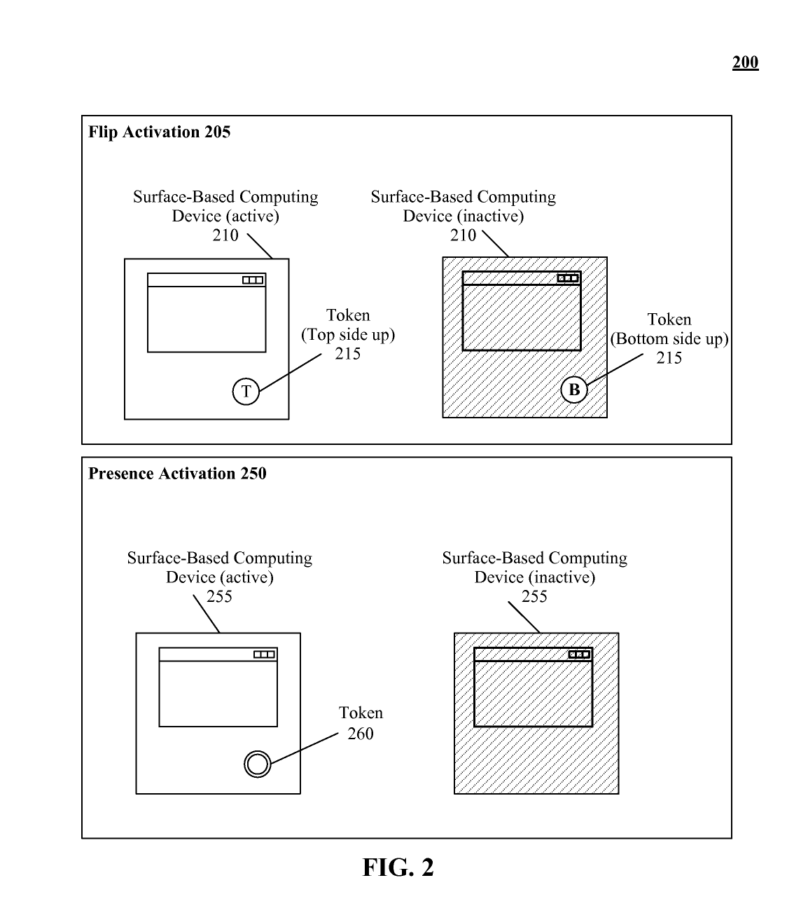

FIG. 2 is a schematic diagram of a system 200 illustrating solutions 205, 250 for using an enablement token 215, 260 to control the enablement state of a surface based computing device 210, 255. The token 215, 255 can be any physical object able to be placed on a surface of the surface based computing device 210, 255.

For example, the token 210 can have two or more surfaces, such as a coin or a die, and an enablement state of the surface based computing device can depend upon which token surface is downward (or upward) facing. The coin or die (token 210) can optionally be labeled or marked so that a user is clear which enablement state is being represented. For instance, a two sided token can be labeled active and inactive so that when an active side is showing and the token 210 is placed on the surface of device 210, the device 210 is activated. As shown by flip activation 205 scenario, when token 215 is top side up, the surface based computing device 210 can be active. When the token is bottom side up 215, the surface based computing device 210 can be inactive.

In one contemplated implementation, an N-sided die (token 215) can be used to represent multiple activate and/or inactive states. For example, different inactive states can include: locked, hibernating, powered down, logged off, and the like. Different active states can represent a level of functionally granted when active, such as guest permissions and functionality active, user permissions and functionality active, and administrative permissions and functionality active.

In another example, the token 260 can be optionally contained within an object, such as a glass, a plate, or a cigarette tray, so that when the object is placed on the surface an enablement state of the surface changes. For instance, a presence of the object 260 (e.g., glass, plate, etc.) can indicate that the surface is being used as a table and that computing functions of the surface based computing device 255 are to be disabled until the object is removed.

Presence activation scenario 250 indicates a presence based enablement situation. As shown, when token 260 is present, the device 255 can be active. When token 260 is absent, the device 255 can be inactive. Scenario 250 is configured directly opposite of the aforementioned situation, in which a device 255 is inactive when an object, such as a glass, is placed on a surface. One specific situation for using a token 260 as shown in scenario 250 is when the token 260 functions as a security artifact, which must be placed upon a surface of device 255 before a user is able to access functionality of the device 255. For example, an “internet enabled” cafe' may have a for-pay surface based computing device 255, where patrons must purchase/rent an activation token 255 before they are able to use the device 255.

In another embodiment, a token 260 can uniquely identify a user, such as by containing an readable RFID tag having a digitally encoded user identification key. In such an embodiment, when the token 260 is placed on the surface of device 255, a user can be automatically logged on to the device 210, 255 and granted a level of access to which the user is authorized.

Regardless of how the token 215, 260 is used to control an enablement state of the device 210, 255, system 200 can ensure that session state information is preserved. That is, when changing from an active state to an inactive state, the device 210, 255 can store/preserve state information. When changing from an inactive state to an active state, stored/preserved state information can be automatically restored. State information can be preserved for an arbitrary amount of time and for a number of different device 210, 260 users. Further, state information can be centrally stored in a data store accessible by a multiple surface based computing devices 210, 255, which enables a user to use any of the devices to continue a previously interrupted session.

For example in a situation based on scenario 250, a first user associated with a user-specific token 260 can remove their token 260, which causes state information for that user to be stored and causes the device 255 to be placed in an inactive state. A second user can then place a different user-specific token 260 upon a surface of device 255, which enables the second user to use the device 255. When done, the second user can remove their token 260, which again results in state information being saved. The first user can return to the device 255 and place their token 260 upon its surface, which results in the first user's session information being retrieved and applied to the surface based computing device 255. While the first user is using the device, the second user can place his/her token 260 upon a different surface based computing device linked to a session state storage data store. The different surface based computing device can be activated for the second user in a state at which the second user ended his/her most recent session.

It should be appreciated that a position/orientation of a token 215, 260 can be detected in many ways. For example, a downward facing side can include a unique characteristic designed to be detected by the surface based computing device 210, 255 when the token 215, 260 is placed on the surface. For example, the token 215, 260 can include a downward facing embossed design, which causes characteristic infrared reflections (from infrared projector produced emissions) to be read by infrared cameras. In another example, a pressure sensor on the token 215 can be selectively depressed when placed on the surface of device 210, which causes a wireless message to be conveyed from the token 215 to the device 210 to indicate which side of the token 215 is downward facing.

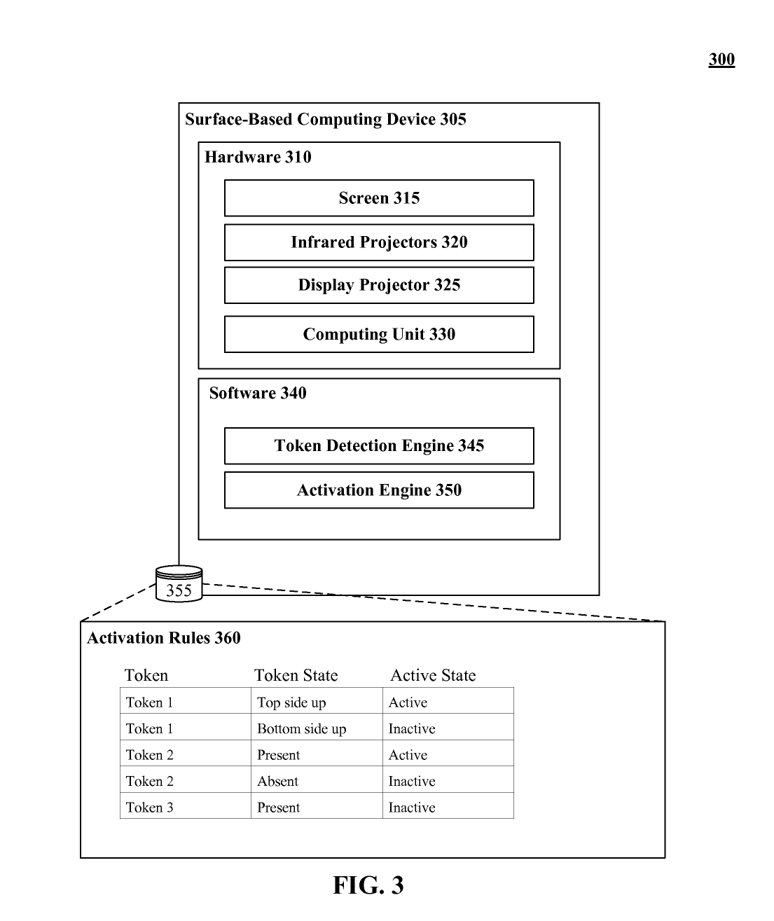

FIG. 3 is a schematic diagram of a system 300 for using a token to control the enablement state of a surface-based computing device in accordance with an embodiment of the inventive arrangements described herein. Surface-based computing device 305 can include hardware 310 and software 340. Hardware 310 can include the necessary devices to create the functionality of a surface-based computing device 305. For example, hardware 310 can include screen 315, a set of infrared projectors 320, at least one display projector 325, and computing unit 330. Software 340 can include necessary machine-readable instructions to allow using a token to control the enablement state of surface-based computing device 305. Software 340 can include token detection engine 345 and activation engine 350.

In system 300, surface-based computing device 305 can use token detection engine 345 in conjunction with infrared projectors 320 and screen 315 to detect whether a token has been placed on the screen 315 and, if so which side(of a multi-sided token) faces downward. Once a position and orientation of the token is know relative to the screen 315 or surface of the device 305, the activation engine 350 can execute actions to make suitable adjustments to an enablement state of device 305. In one embodiment, a table of activation rules 360 can be stored in data store 355, which the activation engine 350 uses to interpret actions to take given a token placement. The activation rules 360 can optionally be user/administrator configurable. The activation engine 350 can also be configured to respond differently to different tokens.

As shown by rules 360, when Token 1 is topside up, the device 305 is to be placed in an active state. When Token 1 is bottom side up, the device 305 is to be placed in an inactive state. When Token 2 is present, the device 305 is to be active, and when Token 2 is absent, the device 305 is to be inactive. When Token 3 is present, the device 305 is to be inactive. An evaluation order or an order of authority can be established so that enablement information indicated of one token takes precedence over another. For example, when Token 1 is present, it can control an enablement state of device 305 regardless of whether Token 2 or Token 3 are present or absent and regardless of what state Token 2 and 3 indicate. The activation rules 360 can be of arbitrary complexity. In one embodiment, combinations of different tokens can affect which actions that activation engine 350 is to take. In another embodiment, a total surface of the device 305 can be segmented so that different activation tokens control an activation state of different segments of the device 305.

Data store 355 of system 200 can be a physical or virtual storage space configured to store digital information. The data store 355 can be physically implemented within any type of hardware including, but not limited to, a magnetic disk, an optical disk, a semiconductor memory, a digitally encoded plastic memory, a holographic memory, or any other recording medium. The data store 355 can be a stand-alone storage unit as well as a storage unit formed from a plurality of physical devices. Additionally, information can be stored within the data store 355 in a variety of manners. For example, information, such as rules 360, can be stored within a database structure or can be stored within one or more files of a file storage system, where each file may or may not be indexed for information searching purposes. Further, data store 355 can optionally utilize one or more encryption mechanisms to protect stored information from unauthorized access.

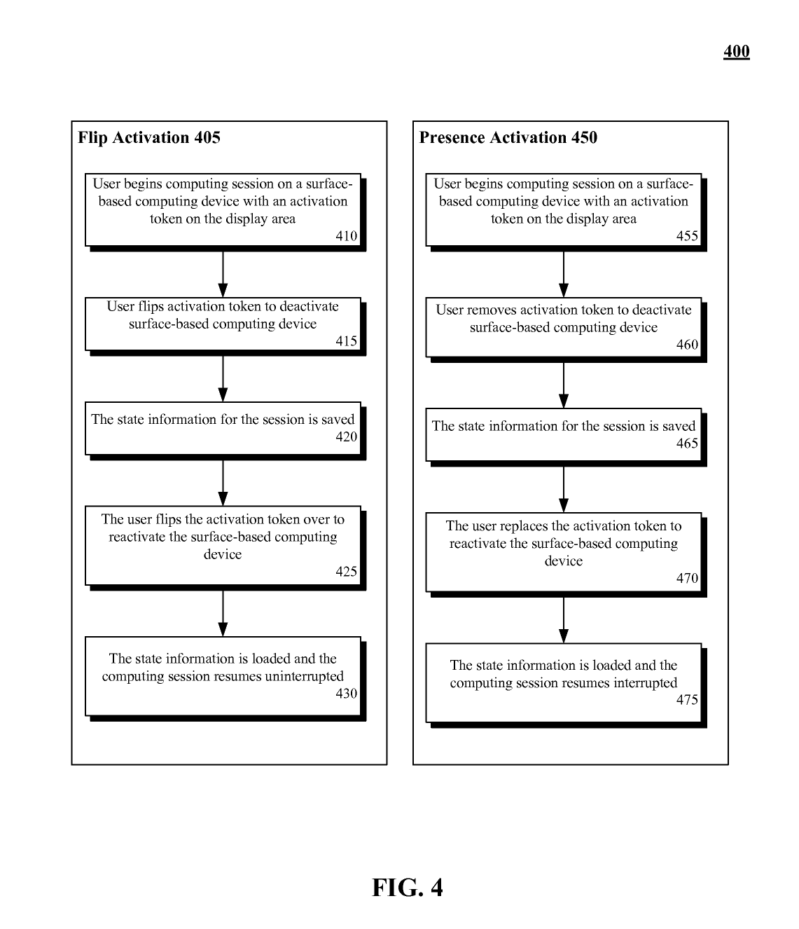

FIG. 4 is a flow chart of a method 400 for using a token to control the enablement state of a surface-based computing device in accordance with an embodiment of the inventive arrangements described herein. Method 400 can be performed in the context of system 300. Method 400 illustrates two solutions for using a token to control the enablement state of a surface-based computing device, flip activation 405 and presence activation 450.

These two solutions are not intended to be comprehensive and other derivative solutions can be used. For example, the solutions can be combined, where a presence of a security token is required, which permits a flip-able activation token, such as an N-sided die, to control an enablement state. In another example, multiple different enablement tokens associated with different users can be required before activating a secured functionality of a surface based computing device.

A basic flip activation scenario 405 can begin in step 410, where a user can begin a computing session on a surface-based computing device with an activation token on the display area. In step 415, the user can flip the activation token to deactivate the surface-based computing device. In step 420, the state information for the computing session can be saved. In step 425, the user can flip the activation token over again to reactivate the surface-based computing device. Flip activation can end in step 430, where the state information can be restored and the computing session can resume uninterrupted.

A basic presence activation 450 can begin in step 455, where a user can begin a computing session on a surface-based computing device with an activation token on the display area. In step 460, the user can remove the activation token to deactivate the surface-based computing device. In step 465, the state information for the session can be saved. In step 470, the user can replace the activation token onto the display area to reactivate the surface-based computing device. Presence activation can end in step 475, where the state information can be restored and the computing session can resume uninterrupted.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for controlling an enablement state of a surface based computing device comprising:
identifying a physical object external to a surface based computing device, which is able to be placed on a surface of the surface based computing device;
the surface based computing device detecting a change in a positioning of the physical object relative to the surface; and
responsive to the positioning change, changing an enablement state of the surface based computing device, whereby positioning of the physical object refers to a presence or absence of the object on the surface as well as which side of an N-sided object is downward facing.

2. The method of claim 1, wherein the change of enablement state is from an active state to an inactive state, said method further comprising:
preserving state information of an active session in a data store accessible by the surface based computing device.

3. The method of claim 2, further comprising:
detecting a second change in a positioning of the physical object relative to the surface;
responsive to the positioning change, retrieving previously stored state information of the active session from the data store;
changing the enablement state of the surface based computing device to an active state; and
applying the retrieved state information to a newly activated session.

4. The method of claim 1, wherein at least one of an original enablement state from which the changing step occurs and a resultant state achieved after the changing state completes is a locked state in which an interactive session is locked.

5. The method of claim 1, wherein the physical object is an N-sided object, wherein when a first side of the N-sided object is faced upwards, the surface based computing device is placed in an active state, and wherein when a second side of the N-sided object is faced upwards, the surface based computing device is placed in an inactive state.

6. The method of claim 1, wherein the first and second sides of the two sided object are marked in a user-readable fashion to permit a user to discern by looking at the N-sided object an enablement state of the surface based computing device.

7. The method of claim 1, wherein when the physical object is placed on the surface, one enablement state results and when the physical object is absent from the surface, a different enablement state results.

8. The method of claim 1, wherein the physical token is a security artifact, which must be placed upon the surface before a user is able to access functionality of the surface based computing device.

9. The method of claim 1, wherein the surface is segmented into a plurality of separate sub regions, wherein the physical object controls an enablement state of one and only one of said sub regions.

10. The method of claim 1, wherein said steps of claim 1 are performed by at least one machine in accordance with at least one computer program stored in a computer readable media, said computer programming having a plurality of code sections that are executable by the at least one machine.

11. A surface based computing device comprising:
an enablement engine of a surface based computing device, wherein said enablement engine is a software engine controlling an enablement state of the surface based computing device, said enablement state comprising at least an active state and an inactive state, wherein state information is preserved when the enablement engine changes from the active state to the inactive state so that when the state is changed back from the inactive state to the active state using the enablement engine, state information is restored; and
an enablement token detector configured to detect a positioning of a physical object relative to a surface of the surface based computing device, wherein different detected positionings of the physical object correspond to different enablement states, wherein when the enablement token detector detects a change in the positioning of the physical object, a command is automatically conveyed to the enablement engine to change an enablement state of the surface based computing device to match an enablement state indicated by the physical token, whereby positioning of the physical object refers to a presence or absence of the object on the surface as well as which side of an N-sided object is downward facing.

12. The device of claim 11, wherein the physical object is a two sided object, wherein when a first side of the two sided object is faced upwards, the surface based computing device is placed in an active state, and wherein when a second side of the two sided object is faced upwards, the surface based computing device is placed in an inactive state.

13. The device of claim 11, wherein when the physical object is placed on the surface, one enablement state results and when the physical object is absent from the surface a different enablement state results.

14. The device of claim 11, wherein the physical object is a security artifact, which must be placed upon the surface before a user is able to access functionality of the surface based computing device.

15. The device of claim 11, further comprising:
at least one infrared projector aimed at the surface, which produce infrared emissions that are reflected back when objects touch the surface;
at least one infrared camera configured to detect reflections of the produced infrared emissions, wherein detected reflections from objects placed on the surface, wherein said objects comprise said physical object;
at least one projector configured to produce visible emissions, which cause images and text to appear upon the surface, wherein the at least one projector is configured to generate visible emissions to produce visual output for the surface; and
a computing unit configured to receives input, to perform processing operations, and to control output for the surface based computer, and wherein computing unit executes code of the enablement engine and code of the enablement token detector.

16. A physical token for controlling an enablement state of a surface based computing device comprising:
at least one unique characteristic that is configured to be detected by a surface based computing device when the physical token is placed on a surface of the surface based computing device, wherein a positioning of the physical token relative to the surface corresponds to different enablement states for the surface based computing device, wherein the different enablement states comprise at least an active state and an inactive state, wherein state information is preserved when the surface based computing device changes from the active state to the inactive state so that when surface based computing device changes back from the inactive state to the active state, state information is restored.

17. The physical token of claim 16, further comprising at least two sides, wherein when a first side of the physical token is faced downwards on the surface, the surface based computing device is placed in an active state, and wherein when a second side of the physical token is faced downwards, the surface based computing device is placed in an inactive state.

18. The physical token of claim 16, wherein when the physical token is placed on the surface, one enablement state results and when the physical object is absent from the surface, a different enablement state results.

19. The physical token of claim 16, wherein the surface based computing device comprises at least one infrared projector aimed at the surface, which produce infrared emissions that are reflected back when objects touch the surface and at least one infrared camera configured to detect reflections of the produced infrared emissions, wherein detected reflections from objects placed on the surface, wherein said unique characteristic of said physical token causes infrared emissions to be reflected in a specific way able to be detected by the at least one infrared camera, wherein these reflections are used to determine the positioning of the physical token relative to the surface.

20. The physical token of claim 16, wherein the physical token is a security artifact, which must be placed upon the surface before a user is able to access functionality of the surface based computing device, wherein the physical token comprises at least one radio frequency identification (RFID) tag that contains a security key, wherein the security key is read from the RFID tag by the surface based computing device to authenticate the physical token.
